(19) United States
(12) Patent Application Publication
(10) Pub. No.: US 2002/0157275 A1
(43) Pub. Date: Oct. 31, 2002

(54) Electric hair treatment appliance

(76) Inventors: Peter Anthes, Erbach (DE); Detler Mattinger, Bickenbach (DE)

Correspondence Address: Striker Striker & Stenby, 103 East Neck Road, Huntington, NY, 11743, US

(21) Appl. No.: 09/936,473

(22) PCT Filed: Jan. 22, 2001
(86) PCT No.: PCT/EP01/00673

(30) Foreign Application Priority Data
Jan. 22, 2000 (DE) 100 02 785.7

(51) Int. Cl. A45D 1/00; F26B 13/10; F26B 21/00

(52) U.S. Cl. 34/96; 34/97; 34/524

(57) ABSTRACT

The invention relates to an electric hair treatment appliance (1) comprising an operating desk (2) that is fixedly connected to the hair treatment appliance (1) and serves for controlling operational parameters. Said desk (2) is provided with an operating and display field (3) which is configured as a circular surface (4) and is embedded in a recess (5) in such a way that said field can be axially rotated together with the circular surface (4).

The invention relates to an electric hair treatment appliance as generically defined by the preamble to claim 1.

A hair treatment appliance defining this generic type is already from European Patent Disclosure EP 0 072 994 A1 of the present Applicant. A solidly connected operator control panel for controlling operating parameters is disposed on the back of this hair treatment appliance, and the operator control panel has a stationary operator control and display field. Because of this construction, this has the disadvantage that the operator control panel can be operated only from the back of the hair treatment appliance.

It is therefore the object of the invention to create a hair treatment appliance of this generic type which does not have this disadvantage and can be conveniently operated selectively from the sides of the hair treatment appliance as well.

This object is attained as defined by the body of claim 1. Further advantageous refinements of the invention are recited in the dependent claims.

Because the operator control and display field is embodied as a circular face and is embedded rotatably, surface-axially, in a receptacle of the operator control panel, operation of the operator control panel of the hair treatment appliance is possible selectively, depending on the manually set rotary position of the operator control and display field, from the back or from both sides. For instance, if the hair treatment appliance is positioned in a tight corner of a hairdressing salon, it is conveniently possible to operate the operator control panel from the side accordingly.

The invention will be explained in further detail in terms of an exemplary embodiment.

Shown are:

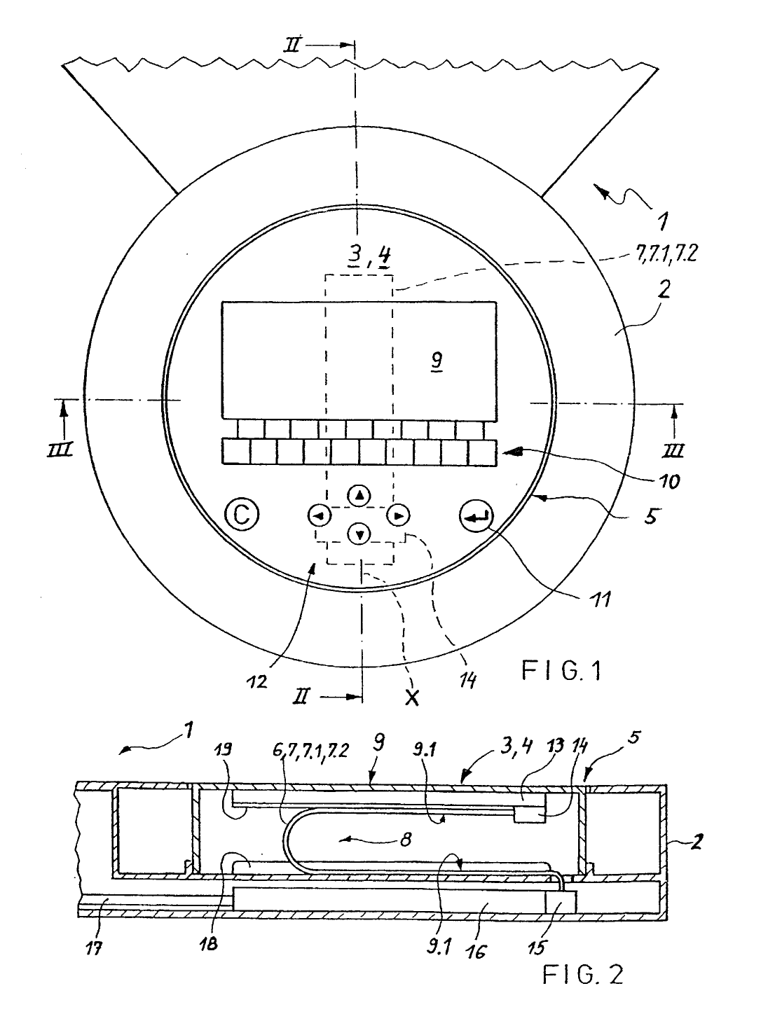

FIG. 1, in a plan view, an operator control and display field with a receptacle;

FIG. 2, in a sectional view, a section taken along the line II-II of FIG. 1;

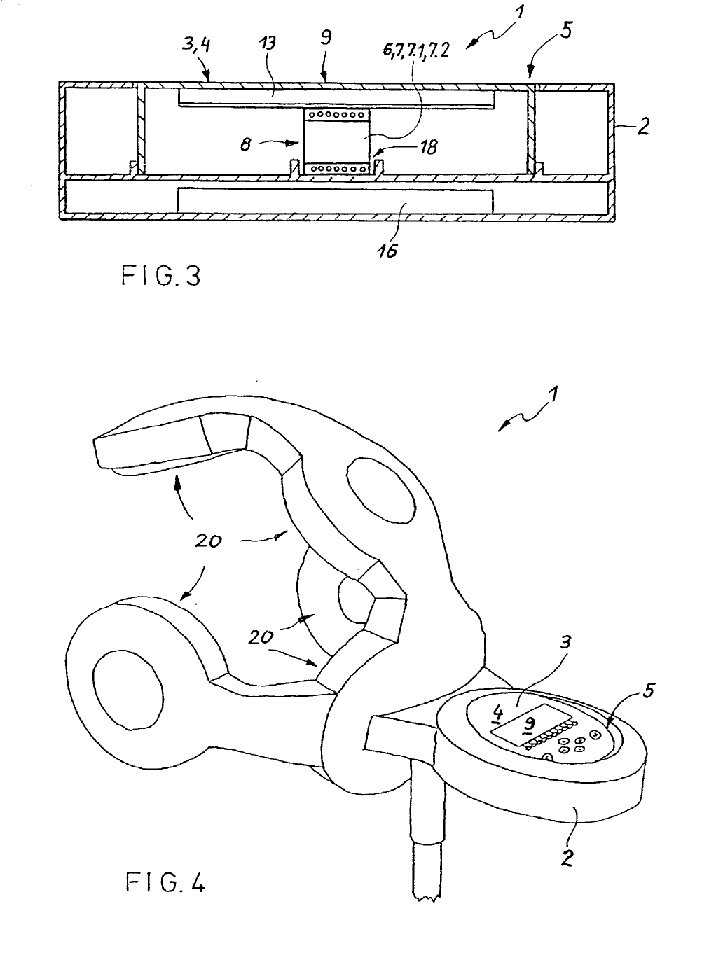

FIG. 3, in a sectional view, a section taken along the line III-III of FIG. 1;

FIG. 4, in a perspective view, a hair treatment appliance with the operator control and display field;

FIGS. 5-8, various positions of a flat cable as a function of the angular position of the operator control and display field; and

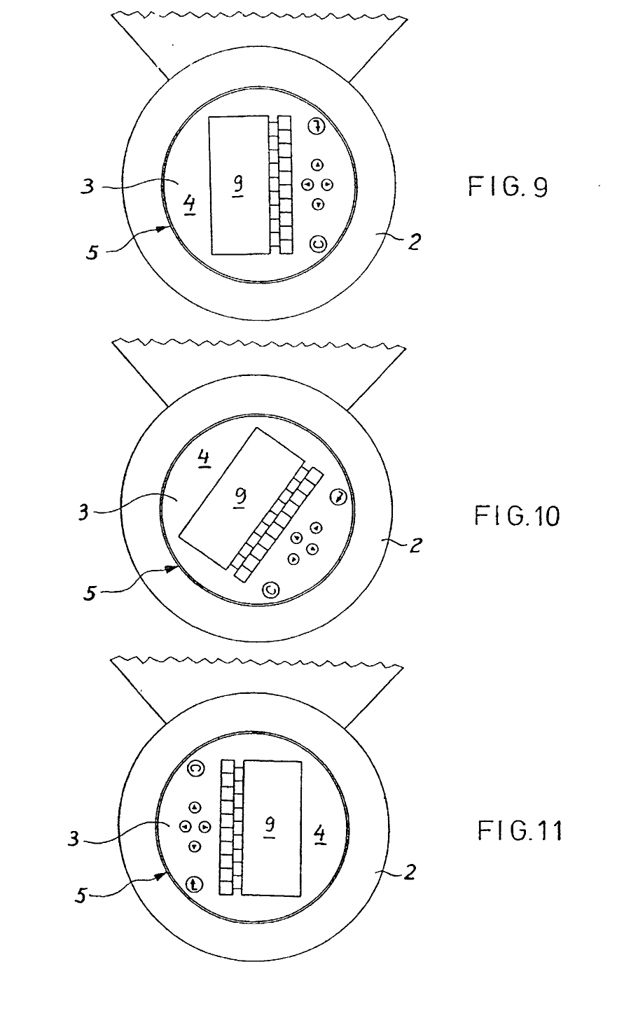

FIGS. 9-11, various angular positions of the operator control and display field.

FIG. 1 shows part of an electric hair treatment appliance 1, with a operator control panel 2 solidly connected to the hair treatment appliance 1 for controlling operating parameters, and the operator control panel 2 has an operator control and display field 3. The operator control and display field 3 is embodied as a circular face 4 and is axially rotatable with the circular face 4 into arbitrary angular positions in a receptacle 5. For inputting and controlling operating parameters, the operator control and display field 3 is provided with a display 9, a plurality of input buttons 10, 11, and a plurality of cursor buttons 12.

In FIG. 2, the section II-II of FIG. 1 is shown; the operator control panel 2 for adjusting the electrical operator control and display field 3 into an arbitrary angular position is shown in more detail here. The operator control and display field 3 is preferably embodied as rotatable outward from the middle angular position X by at least +/−90°. Within the scope of familiar professional provisions, suitable rotary stops (not otherwise shown) should be provided, along with a suitable rotary bearing of the operator control and display field 3. As an electrical connection 6 between the receptacle 5 and the operator control and display field 3, a flat cable 7 is provided, which in FIG. 1, in a neutral middle angular position X of the operator control and display field 3, essentially forms a U-shaped loop 8 and which is disposed with its flat sides 9.1 between the receptacle 5 and the operator control and display field 3. A printed circuit board 13 with suitable components is disposed below the operator control and display field 3; one end of the flat cable 7, which for the sake of better flexibility is used in the form of a stranded flat cable 7.1 or a conductor track foil 7.2, is electrically connected to the printed circuit board 13 via a connection 14. The other end of the flat cable 7, 7.1 is electrically connected via a further connection 15 to a further printed circuit board 16, and from the printed circuit board 16, a cable 17 for electrical functions leads out into the hair treatment appliance 1. The lower part of the flat cable 7, 7.1 or conductor track foil 7.2 is held and guided against any slippage by a groove 18. To minimize friction of the upper part of the flat cable 7, 7.1, the lower side of the printed circuit board 13 is provided with a slip foil 19.

FIG. 3 shows a section III-III from FIG. 1, and FIG. 4 shows the hair treatment appliance 1 for a hairdressing salon; it is capable of outputting a controlled emission of heat and a selective flow of heat for treating hair on a person's head. Instead of elongated infrared emitter elements as in EP 0 072 994 A1 (FIGS. 1 and 5), here circular infrared emitter elements 20 (FIG. 4) with a selective heat flow are provided.

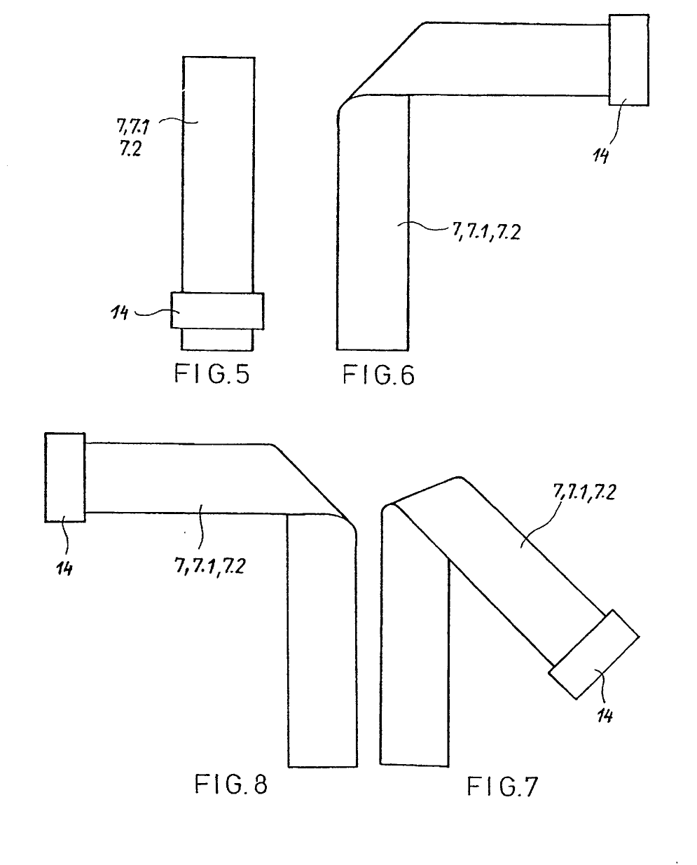

In FIGS. 5-8, various positions of the flat cable 7, 7.1, 7.2 are shown, depending on the angular position of the operator control and display field 3. The position in FIG. 5 is equivalent to the neutral angular position X of FIG. 1. The position of FIG. 6 corresponds to the angular position (90°) of FIG. 9. The position of FIG. 7 corresponds to the angular position (45°) of FIG. 10. The position of FIG. 8 corresponds to the angular position (90°) of FIG. 11.

### LIST OF REFERENCE NUMERALS

1 Hair treatment appliance

2 Control panel

3 Control and display field

4 Circular face

5 Receptacle

6 Connection

7 Flat cable

7.1 Stranded flat cable

7.2 Conductor track foil

8 Loop

9 Display

9.1 Flat side

10, 11 Input buttons

12 Cursor buttons

13 Printed circuit board

14 Connection

15 Connection

16 Printed circuit board

17 Cable

18 Groove

19 Slip foil

20 Infrared emitter element

1. An electric hair treatment appliance (1), having a operator control panel (2) solidly connected to the hair treatment appliance (1) for controlling operating parameters, the operator control panel (2) having an operator control and display field (3), characterized in that the operator control and display field (3) is embodied as a circular face (4) and is embedded axially rotatably with the circular face (4) in a receptacle (5).

2. The device of claim 1, characterized in that as an electrical connection (6) between the receptacle (5) and the operator control and display field (3), a flat cable (7) is provided, which in a middle angular position (X) of the by operator control and display field (3) essentially forms a U-shaped loop (8) and which is disposed with its flat sides (9) between the receptacle (5) and the operator control and display field (3).

3. The device of claim 2, characterized in that a stranded flat cable (7.1) or a flexible-elastic conductor track foil (7.2) is provided.

4. The device of claim 1, characterized in that the operator control and display field (3) is embodied as rotatable outward from the middle angular position (x) by at least +/−90°.
